(19) United States
(12) Patent Application Publication
(10) Pub. No.: US 2022/0215191 A1
(43) Pub. Date: Jul. 7, 2022

(54) MATRIX CODE ENABLED DRINKING CUP AND METHOD OF IDENTIFYING A USER OF A CUP

(71) Applicant: Scott Brownsberger, El Segundo, CA (US)

(72) Inventor: Scott Brownsberger, El Segundo, CA (US)

(21) Appl. No.: 17/143,248

(22) Filed: Jan. 7, 2021

(51) Int. Cl. G06K 7/14; B65D 1/26; B65D 1/40; A47G 19/22; G06K 7/10

(52) U.S. Cl. CPC G06K 7/1417; B65D 1/265; G06K 7/10722; A47G 19/2227; B65D 1/40

(57) ABSTRACT

A system for identifying a cup of a user is provided. The system has a plurality of cups, wherein each of the plurality of cups comprises a unique matrix code, a smartphone comprising a user interface, a camera, a memory storing instructions, and a processor configured to execute the instructions to configure, by the processor, the camera to scan one or more matrix codes, scan, by the camera, a matrix code, wherein the matrix code comprises data representing which of the plurality of cups the scanned cup is, determine, by the processor, that the scanning of the matrix code is completed; scan, by the camera, the users face to associate the user with one of the plurality of cups, automatically populate, by the processor, the user interface with the data representing the user based on the scanned matrix code and scanned face. The cup has a fiber consisting essentially of a polyethylene terephthalate polymer composition is disclosed.

### FIELD OF THE INVENTION

The present invention generally relates to drinking cups and the manufacture thereof. More specifically, the present invention relates to drinking cups having a matrix code identifier such as a QR code and a networked gaming application for users to participate in certain games and tasks based on the cup identification.

### BACKGROUND

A pandemic is an epidemic of an infectious disease that has spread across a large region, for instance multiple continents or worldwide, affecting a substantial number of people. Recently, The COVID-19 pandemic, also known as the coronavirus pandemic, is a pandemic of coronavirus disease 2019 (COVID-19), caused by severe acute respiratory syndrome coronavirus. The World Health Organization declared the outbreak a Public Health Emergency of International Concern on 30 Jan. 2020.

In response, many governments across the world have either declared or recommended that people “social distance” to obviate the spread of the disease. In public health, social distancing, also called physical distancing, is a set of non-pharmaceutical interventions or measures intended to prevent the spread of a contagious disease by maintaining a physical distance between people and reducing the number of times people come into close contact with each other. It typically involves keeping a certain distance from others (the distance specified may differ from time to time and country to country) and avoiding gathering together in large groups. In the United States, the recommend distance is six feet. By reducing the probability that a given uninfected person will come into physical contact with an infected person, the disease transmission can be suppressed, resulting in fewer deaths.

However, even when people are social distancing, drinking vessels like cups can easily be mixed up, especially considering many disposable cups have the same appearance.

Furthermore, users, especially younger users, enjoy integrating their smartphone device into everyday life and use their phone for games and other tasks. Currently, there are no cups that can identify the owner or user of a cup using a mobile application or the internet, and identifying those users that are participating in certain games based on the identification.

Thus, what is needed is an environmentally friendly disposable cup that is identifiable to the user using their smartphone to lessen or obviate the chance of people accidently sharing cups during get togethers, while also providing for fun games to play using the cup.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

To achieve the foregoing and other aspects and in accordance with the purpose of the invention, a disposable cup or vessel and a method of manufacture is provided.

Accordingly, the disclosure relates to a disposable cup manufactured from post-consumer PET, each of the cups in a sleeve having a unique identifier on the cup.

Accordingly, this disclosure relates to a disposable cup that is identifiable to a user or group of users using a matrix code such as a QR code, and provides certain information to a mobile application using the QR code so that the user or group of users can see who is participating in one of a group of games (e.g., beer pong or Beirut, flip cup, chandeliers, etc.) and the user can identify his or her cup based on automatic recognition by the camera and/or sensors of a smartphone to populate a GUI and further, utilize a sensor in the cup to calculate an amount of liquid in the cup.

In embodiments, a cup is provided having a QR code affixed thereto in any manner and a name (e.g., a made up name such as “Susie Q” or “Jumping Jack Flash”). In this way, it converts the code to some useful form such as a standard URL for a website, or automatically takes the user to a mobile application where the users participating in the game or task, and what games they are playing. In this way, users can know which cup is theirs in a “touchless” manner to avoid the spread of germs. Further, because of the names provided, the user can easily identify his or her cup and his or her “name” (e.g., Jumping Jack Flash”) on the UI.

In embodiments, the cup comprises a unique identifier. In a sleeve of cups, each identifier is unique when compared to the other cups in the sleeve.

In an embodiment, a drinking cup is provided comprising a top portion, a side portion and a bottom portion; a matrix code (e.g., QR code) affixed to the side portion thereto; a unique identifier affixed to the side portion; wherein the QR code, when scanned by the user, is configured to link the cup to the unique identifier and a data set representing which of the plurality of cups the scanned cup is.

In embodiments, a system for identifying a cup of a user, is provided comprising a plurality of cups, wherein each of the plurality of cups comprises a unique QR code; a smartphone comprising a user interface, a camera, a memory for storing instructions; and a processor configured to execute the instructions to configure, by the processor, the camera to scan one or more QR codes; scan, by the camera, a QR code, wherein the QR code comprises data representing which of the plurality of cups the scanned cup is; determine, by the processor, that the scanning of the QR code is complete; scan, by the camera, a face of the user to associate the user with one of the plurality of cups; automatically populate, by the processor, the user interface with data representing the user based on the scanned QR code and scanned face.

In embodiments, a processor-based method for identifying a cup of a user is provided. The method comprises providing a plurality of cups, wherein each of the plurality of cups comprises a unique QR code; providing a smartphone comprising a user interface, a camera, a memory storing instructions; and a processor; scanning, by the camera, a QR code, wherein the QR code comprises data representing which of the plurality of cups the scanned cup is; determining, by the processor, that the scanning of the QR code is complete; scanning, by the camera, the users face to associate the user with one of the plurality of cups; automatically populating, by the processor, the user interface with the data representing the user based on the scanned QR code and scanned face.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a side view of the cup consisting essentially of post-consumer PET and having a unique identifier thereon in one embodiment of the present invention.

FIG. 2 illustrates an opposite side view of the cup in which the QR code is shown in one embodiment of the present invention.

FIG. 3 illustrates a top view of the cup showing a sensor therein in one embodiment of the present invention.

FIG. 4 illustrates an exemplary user interface in one embodiment of the present invention.

FIG. 5 illustrates an exemplary step-wise diagram of a method according to an embodiment of the present invention.

Other features, advantages, and aspects of the present system will become more apparent and be more readily understood from the following detailed description, which should be read in conjunction with the accompanying drawings.

### DETAILED DESCRIPTION OF THE INVENTION

The present invention is best understood by referencing the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Embodiments of the invention are discussed below with reference to the examples. However, those skilled in the art will readily appreciate that the detailed description given herein with respect to these examples is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

For purposes of illustrating features of the embodiments, a simple example will now be introduced and referenced throughout the disclosure. Those skilled in the art will recognize that this example is illustrative and not limiting and is provided purely for explanatory purposes. An example of a computing system environment is disclosed. Any computing system environment is not intended to suggest any limitation as to the scope of use or functionality of the system and method described herein. Neither should the computing environment be interpreted as having any dependency or requirement relating to any one or combination of components illustrated in the exemplary operating environment.

As used herein, the term “QR Code” is a Quick Response code and is a type of matrix barcode (or two-dimensional barcode) though other scannable codes may be used.

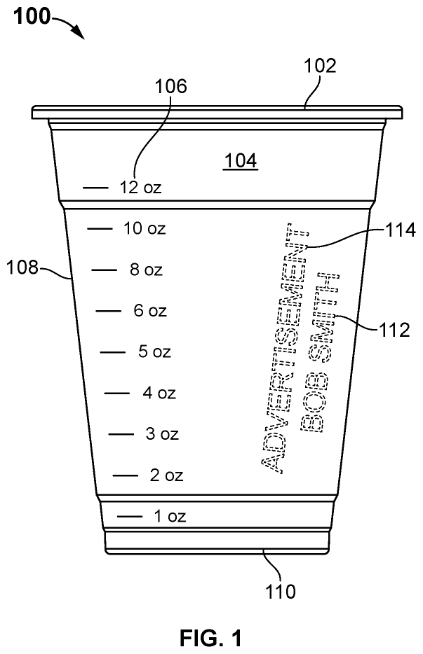

Referring now to FIG. 1, a side view of the cup 100 is shown. The cup comprises top 102 (open portion for drinking), body 104, measurement notches 106, side 108, bottom 110, unique identifier 112, and space for advertisement 114. The cup comprises recycled polymer compositions prepared from post-consumer PET. For example, a recycled polymer composition can be prepared from homogenized post-consumer polyethylene terephthalate, which can be present in pelletized form, in flaked form, or in a combination thereof. As further examples, recycled polymer compositions can be provided as polymer mixtures, as extruded polymer compositions, as fibers, and/or as bulked continuous filament fibers.

In one aspect, a recycled post-consumer polymer (e.g., curbside post-consumer polyethylene terephthalate) composition can be extruded to provide a bulked continuous filament fiber.

In embodiments, the cup comprising a fiber consisting essentially of a post-consumer polyethylene terephthalate polymer composition, wherein the polyethylene terephthalate polymer composition has greater than 80% by weight to about 100% by weight of homogenized curbside post-consumer polyethylene terephthalate, the balance being virgin polyethylene terephthalate.

In embodiments, the cup comprises a fiber consisting essentially of comprising polyethylene terephthalate polymer composition has at least about 85% by weight of homogenized curbside post-consumer polyethylene terephthalate.

In embodiments, the cup comprising a fiber consisting essentially of comprising polyethylene terephthalate polymer composition has at least about 90% by weight of homogenized curbside post-consumer polyethylene terephthalate.

In embodiments, a cup comprising a fiber consisting essentially of comprising polyethylene terephthalate polymer composition has at least about 95% by weight of homogenized curbside post-consumer polyethylene terephthalate.

The unique identifier 112 may comprise random names on each cup in the sleeve so that the user knows which cup is his or her if the user puts it down during a gathering and or get together, and these names, in embodiments, may populate on the mobile application when the QR code is scanned by the user. This helps to ensure bacteria and viruses are not spread amongst users. While random names may be used, random phrases or letters and colors may be used as well. Also, in embodiments, a user may be capable of writing on the cup using their finger. Further, there is room for an advertisement at section 114.

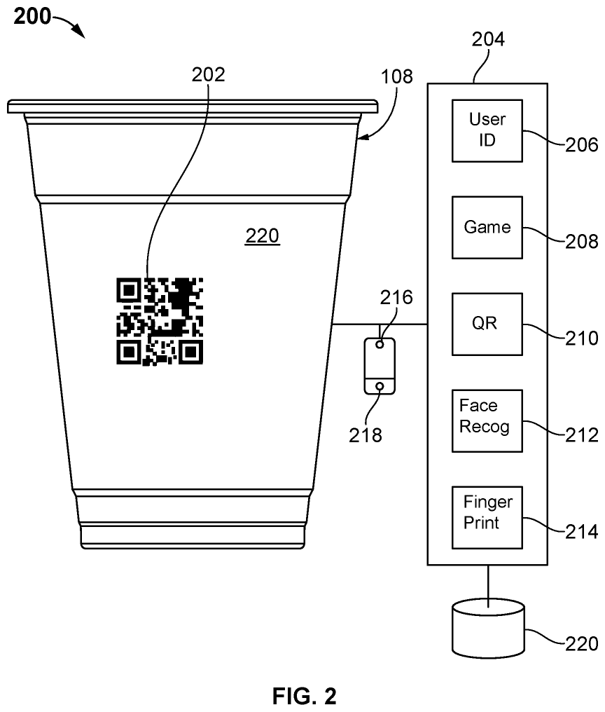

Now with reference to FIG. 2, an opposite side view of the cup of FIG. 1 is shown. In this embodiment, a QR code 202 is shown printed thereon the opposite side 220. A mobile application 204 is provided and is readable by the camera 216 of a smartphone 218. The smartphone 218 comprises mobile application 204 which is downloadable thereto or thereon. The mobile application 204 is in communication with a network and server. The smartphone comprises a display, a memory storing instructions, and a processor configured to execute the instructions. The processor is configured to execute the instructions to determine a game that is played by the user and display who the user of the cup of a plurality of cups is. Also, the processor is configured to communicate with a database 220 which stores historical data and the data associated with each QR code on certain cups of the plurality of cups. While a smartphone is shown, the smartphone may each be any type of mobile device for communicating with one another, for example, it may be tablets, smart watches, or any other appropriate mobile computing platform or device capable of exchanging data with a network and reading QR codes.

The mobile application 204 comprises a user ID module 206, a game module 208, QR module 210, face recognition module 212 and fingerprint module 214. The mobile application is in communication with a database 220 to store historical data and user data which is accessible by the mobile application.

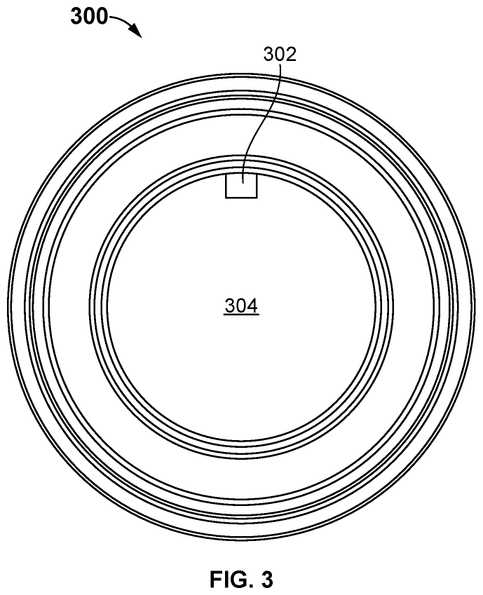

In an embodiment, the ID module 206 is in communication with the smartphone 218. The plurality of cups may be provided in a sleeve having for example, 20-50 cups. Each cup has a different name on it such as “Susie Q” or “Jumpin Jack Flash”. When a user chooses a cup and scans the QR code with their mobile device, the user interface (UI) on the user's smartphone automatically populates with the name on the user's cup (e.g., Susie Q” or “Jumpin Jack Flash”) using the QR module 210 and the user ID module 206. The game module 208 is in communication with the network and allows users to choose a game to play, or in other embodiments, once the user list reaches a predetermined number of users or players, the processor automatically chooses a game to play out of a list of games, and sends a notification to each of the users that are logged in with a notification. The UI on the smartphone 218 receives an output from the mobile application and notifies the user via an audible sound or tactile response such as a vibration that the game will begin. Further, a sensor is provided in the cups to track game performance (discussed with relation to FIG. 3) via wireless communication with the mobile application. The QR module 210 is in communication with the network and processor, and is configured to use the input from the camera and populate the UI with the name associated with that cup via database 220 in communication with the mobile application to store the predetermined QR code association with the name on the cup, historical data and user data which is accessible by the mobile application.

In another embodiment, in operation, the camera 216 of smartphone 218 reads the unique QR code 202 on each cup. At least each sleeve of cups comprises cups that have unique QR codes 202, but in embodiments, all cups may have unique QR codes printed thereon. Once the smartphone processes the QR code 202, the smartphone launches a mobile application for the user. The face recognition module 212 then communicates with the camera 216 to identify the user, and connect that user to the QR code 202 so that users information populates the UI with each cup that is being used and by which user the cup belongs to. As an example, if ten people are using the cups, the UI will populate with each user's information (name, avatar, actual face, etc.) and it is tied to the QR code 202 in that way. Thus, a list of ten users and their cups are identifiable using the camera, QR code 202, and modules 206-214 of the mobile application 204.

The ID module 206 is in communication with the smartphone 218 and the camera 216 and retrieves the face of a user for facial recognition via face recognition module 212. The game module 208 is in communication with the network and allows users to choose a game to play, or in other embodiments, once the user list reaches a predetermined number of users or players, the processor chooses a game to play out of a list of games, and sends a notification to each of the users that are logged in. A sensor is provided in the cups to track game performance (discussed with relation to FIG. 3). The QR module 210 is in communication with the network and processor, and is configured to use the input from the camera and populate the UI. Further, the mobile application is in communication with a database 220 to store historical data and user data which is accessible by the mobile application.

The process is entirely automated utilizing hardware and software once the user scans the code using his or her smartphone, and the Bluetooth® enabled sensor that automatically communicates with a mobile application to track game or task progress. In optional embodiments, the gyroscope and accelerometer of the smartphone are in communication with the sensor of the cup and the mobile application so that additional data can be gathered for other games. As an example, a game may employ attaching the phone on a user's head to see how still they are whilst drinking from the cup. By attaching the phone to the user and having all components in communication, the user's motion can be tracked as well. A smart watch may be utilized in place of the smartphone as well.

Referring now to FIG. 3, a bottom view of the cup of FIGS. 1 and 2 is shown. In this embodiment, a transducer or sensor 302 is disposed proximate the bottom 304 of the cup. The sensor 302 may be a pressure sensor and may comprise a Bluetooth® element or other communication interface. In this way, the sensor 302 may sense how much liquid is in the cup, and relay the sensed information to the mobile application 204. Also, the sensor may comprise a an accelerometer or gyroscope to relay a dimensional position of the cup (e.g., if the cup is upside down during a game of flip cup) to the mobile application 204 for registering in the UI to track the game winners.

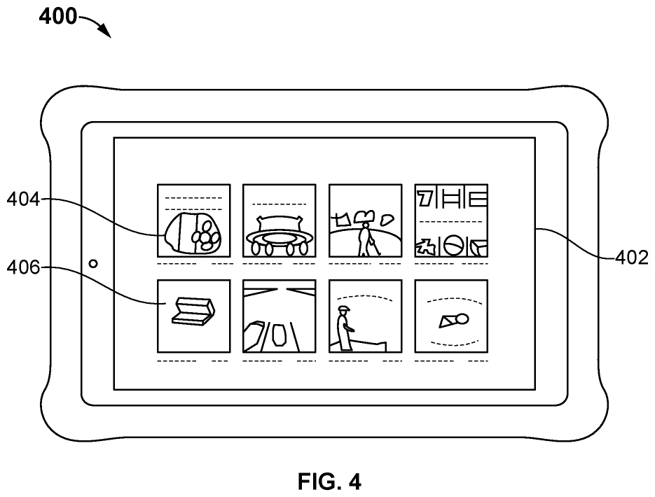

Referring now to FIG. 4, an exemplary UI of the mobile application is shown generally at 400. In current embodiments, a user would see the game selection screen 402 when the user scans the QR code, or when it scans both the QR code and their own face. In the current embodiment the game selection screen 402 may display all of the available games that the user may participate it. In optional embodiments, the game selection screen 402 may include a link that allows the user to visit a third-party external location (e.g., website or application store) where it may purchase additional games. As an example, game 404 may be flip cup, game 406 may be beer pong.

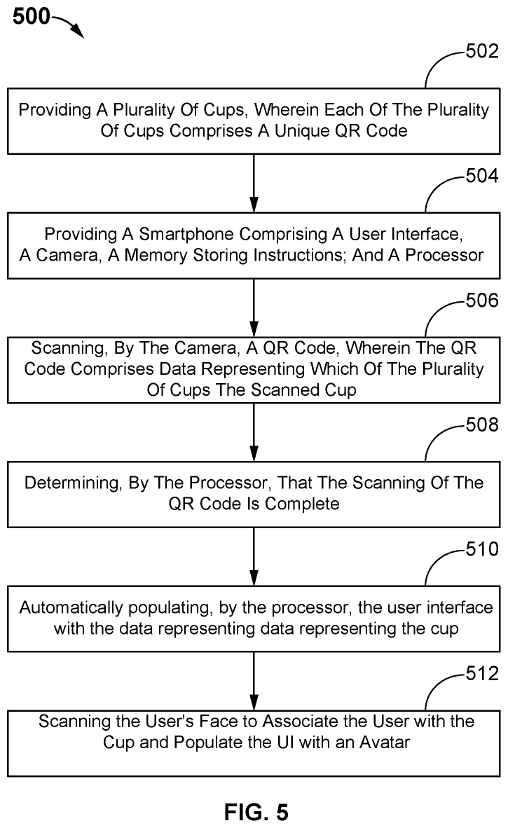

FIG. 5 illustrates a step-wise diagram for a processor-based method for identifying a cup of a user is provided. The method comprises at step 502 providing a plurality of cups, wherein each of the plurality of cups comprises a unique QR code; at step 504 providing a smartphone comprising a user interface, a camera, a memory storing instructions; and a processor; at step 506 scanning, by the camera, a QR code, wherein the QR code comprises data representing which of the plurality of cups the scanned cup is; at step 508 determining, by the processor, that the scanning of the QR code is complete; at step 510 automatically populating, by the processor, the user interface with the data representing the data representing the cup; at step 512 scanning, by the camera, the users face to associate the user with one of the plurality of cups and populate the UI with an avatar; and at step 512, optionally, automatically populating, by the processor, the user interface with the data representing the user based on the scanned QR code and scanned face.

Preferred embodiments of this invention are described herein, including the best mode known to the inventors for carrying out the invention. It should be understood that the illustrated embodiments are exemplary only and should not be taken as limiting the scope of the invention.

Although specific features of various embodiments of the invention may be shown in some drawings and not in others, this is for convenience only. In accordance with the principles of the invention, the feature(s) of one drawing may be combined with any or all of the features in any of the other drawings. The words “including,” “comprising,” “having,” and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

I claim:

1-6. (canceled)

7. A system for identifying a cup of a user, the system comprising:
a plurality of cups, wherein each of the plurality of cups comprises a unique matrix code;
a first smartphone comprising a first user interface, a first camera, a first memory for storing instructions; and a first processor configured to execute the instructions to:
configure, by the first processor, the first camera to scan one or more unique matrix codes;
scan, by the first camera, the unique matrix code, wherein the unique matrix code comprises data representing which of the plurality of cups the scanned cup is;
determine, by the processor, that the scanning of the matrix code is complete;
automatically populate, by the first processor, the first user interface with data representing one of the unique cups;
a second smartphone comprising a second user interface, a second camera, a second memory for storing instructions; and a second processor configured to execute the instructions to:
configure, by the second processor, the second camera to scan one or more unique matrix codes;
scan, by the second camera, another unique matrix code, wherein the unique matrix code comprises data representing which of the plurality of cups the scanned cup is;
determine, by the second processor, that the scanning of the another matrix code is complete;
automatically populate the second user interface with data representing the unique cup and another of the unique cups, wherein the data is a request for participation in a game or task for the first and second user to view;
a server, via the processor, configured to communicate with the first smartphone and second smartphones and populate both the first smartphone and second smartphone with a user interface for the game or task, wherein the user interface on the first and second smartphone are for a same game or task;
wherein the processor is configured to send a notification to the first and second processor that the game or task is ready to be initiated on the first smartphone and second smartphone;
wherein each of the first user and second user, utilizing each of the first smartphone and second smartphone user interfaces and their respective cups, play the same game or task together.

8. The system of claim 7, wherein the process is configured to receive an input based on a scan of a user's face to associate the user with one of the plurality of cups.

9. The system of claim 7, further comprising a mobile application downloadable on the smart phone, the mobile application comprising:
a user identification module in communication with the smartphone and configured to retrieve a face of the user via a face recognition module and populate the UI with the user;
a game module configured to populate the UI with the game or task; and
a matrix module configured to process the matrix code for recognition.

10. The system of claim 7, further comprising a sensor disposed proximate a bottom of the cup, wherein the sensor comprises:
a pressure transducer configured to sense an amount of liquid in the cup by weight; and
a communication interface configured to relay the sensed information to the mobile application.

11. A processor-based method for identifying a cup of a user, the method comprising:
receiving, at a server from a first smart device, data representing a unique matrix code residing on a first cup of a plurality of cups;
receiving, at the server from a second smart device, data representing another unique matrix code residing on a second cup of a plurality of cups;
receiving, at the server from the first smart device, a facial scan of a first user using the first cup of a plurality of cups;
receiving, at the server from the second smart device, a facial scan of a second user using the second cup of the plurality of cups;
automatically populating the first and second smart devices with data representing the unique cup and another of the unique cups, wherein the data is a request for participation in a game or task for the first and second user to view.
communicating with the first and second smartphones and populate both the first and second smartphone with a user interface for the game or task, wherein the user interface on the first and second smartphone are for the same game or task;
sending a notification to the first and second processor that the game or task is ready to be initiated on the first and second smartphone;
utilizing each of the first and second smartphone user interfaces and their respective cups so the first user and the second user play the same game or task together.

12. The method of claim 11, further comprising downloading a mobile application to a smartphone, wherein the mobile application comprises:
a user identification module in communication with the smartphone and configured to retrieve a face of the user via a face recognition module and populate the UI with the user;
a game module configured to populate the UI with the plurality of games or tasks; and
a matrix module configured to process the matrix code for recognition.

13. The method of claim 12, further comprising a sensing an amount of liquid in the cup by weight via a pressure transducer and relaying the sensed information to the mobile application via a communication interface.

14. The method of claim 11, wherein the cup comprises a fiber consisting essentially of comprising polyethylene terephthalate polymer composition having at least 85% by weight of homogenized curbside post-consumer polyethylene terephthalate.
